(19) United States
(12) Patent Application Publication
(10) Pub. No.: US 2026/0030012 A1
(43) Pub. Date: Jan. 29, 2026

(54) TRANSIT OR IN STORAGE SOFTWARE UPDATING SYSTEM AND METHOD

(71) Applicant: Dell Products L.P., Round Rock, TX (US)

(72) Inventors: Marcus Daniel Molner, Austin, TX (US); Suraj M Varma, Portland, OR (US); Kearson M. McNulty, Austin, TX (US); Walter Kemp, Georgetown, TX (US); Trent A. Buys, Seattle, WA (US); Jimmy L. Griffith, Pflugerville, TX (US); David Allen Dyson, Pflugerville, TX (US)

(73) Assignee: Dell Products L.P., Round Rock, TX (US)

(21) Appl. No.: 18/786,759

(22) Filed: Jul. 29, 2024

(51) Int. Cl. G06F 8/65

(52) U.S. Cl. CPC G06F 8/65

(57) ABSTRACT

Embodiments of the present disclosure provide a software updating system and method that updates software in IHSs while in transit or while in storage to keep the software images up to date with the latest fixes and security patches. According to one embodiment, an Information Handling System (IHS) includes executable instructions to, after manufacture of a target computing device and before end user access to the target computing device, communicate with a vendor support site to identify a version of software on the target computing device, download the version of software from the vendor support site, and communicate with the target computing device to install the version of software on the target computing device.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Various hardware components of an IHS may operate using software or firmware instructions. From time to time, it is expected that software utilized by hardware components of an IHS may be updated. Such software updates may be made in order to modify the capabilities of a particular hardware component, such as to address security vulnerabilities or to adapt the operations of the hardware component to a specific computing task. When software updates are made to a hardware component of an IHS, it is preferable that the IHS experience no downtime and with minimal degradation in the performance of the IHS.

### SUMMARY

Embodiments of the present disclosure provide a software updating system and method that updates software in IHSs while in transit or while in storage to keep the software images up to date with the latest fixes and security patches. According to one embodiment, an Information Handling System (IHS) includes executable instructions to, after manufacture of a target computing device and before end user access to the target computing device, communicate with a vendor support site to identify a version of software on the target computing device, download the version of software from the vendor support site, and communicate with the target computing device to install the version of software on the target computing device.

According to another embodiment, a software updating method includes the steps of, after manufacture of a target computing device and before end user access to the target computing device, communicating with a vendor support site to identify a version of software on the target computing device, downloading the version of software from the vendor support site, and communicating with the target computing device to install the version of software on the target computing device.

According to yet another embodiment, an Information Handling System (IHS) is configured with executable instructions to, when a target computing device is at least one of in transit or in storage, communicate with a vendor support site to identify a version of software on the target computing device, download the version of software from the vendor support site, and communicate with the target computing device to install the version of software on the target computing device.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example software updating system that may be used to update the software in an IHS while in transit or in storage according to one embodiment of the present disclosure.

FIG. 2 is a block diagram illustrating components of an example IHS that may be configured to provide the storage updating system according to one embodiment of the present disclosure.

FIG. 3 illustrates several components of the software updating device that may be used to implement the in transit or storage software updating system according to one embodiment of the present disclosure.

FIG. 4 illustrates an example in transit or storage software updating method that may be used to update the software on a target IHS while in transit or in storage according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Nowadays, software updates are typically made available on one or more download sites as soon as the software provider can produce them. In this manner, software providers can be more responsive to critical flaws, security concerns, and general customer needs. To update software, a customer would query an update site for software updates, and download and install the software update if available. For example, a typical network-based software update procedure may include the steps of issuing a request over a network to a software provider's download site (e.g., update source) for a software update applicable to the client computer. The update source responds to the client computer with the software update requested by the client computer in the update request. After the client computer has received the software update, the client computer installs the received software update.

One benefit of updating software in such a manner is the reduced cost associated with producing and distributing software updates. Additionally, software updates can now be performed more frequently, especially those that address critical issues and security. Furthermore, a computer user has greater control as to when and which software updates should be installed on the client computer.

System hardware components of an IHS, such as CPUs, DIMMs, PICe Cards (e.g., Graphics, Network, WiFi, etc.), SSD/HDD devices and the like may need updating for assorted reasons. In many cases, when the end user of an IHS unboxes it, the software for various updatable software images may be obsolete. That is, from the time a piece of software is released or otherwise made available to the time it's integrated into the factory, used in the manufacturing process, and that system shipped and sold to an end user, weeks or months may have gone by. During this time, critical bugs and/or security vulnerabilities are revealed and addressed, but the system may become vulnerable due to outdated firmware or software. As will be described in detail herein below, embodiments of the present disclosure provide a solution to the aforementioned problems, among others, using a software updating system and method that updates software in IHSs while in transit or while in storage to keep the software images up to date with the latest fixes and security patches. In some embodiments, the software updating system and method may reduce effort and time required to bring the IHS up to date once brought online following transit or storage to the end user.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

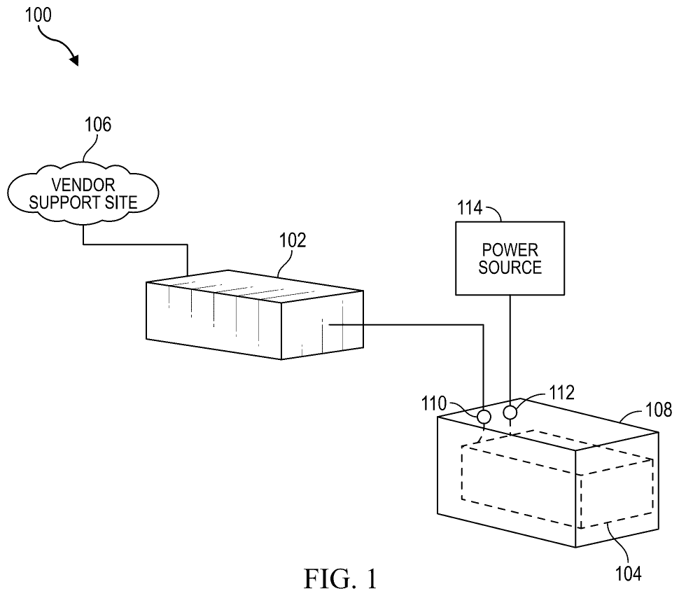

FIG. 1 illustrates an example software updating system 100 that may be used to update the software in an IHS while in transit or in storage according to one embodiment of the present disclosure. The software updating system 100 includes a software updating device 102 configured to be coupled to an online vendor support site 106 and a target IHS 104 for updating the software on the target IHS 104. The target IHS 104 is configured in a shipping container 108 with a communication connector 110 that provides for communication with the target IHS 104, and an optional power connector 112 for powering the target IHS 104 by a power source 114 while it is being updated. Nevertheless, it should be appreciated that in other embodiments, the target IHS 104 may be housed in any suitable structure, or in no structure at all, such as at any time between manufacture of the target IHS 104 and initial use of the target IHS 104 by the end user.

Generally speaking, the software updating device 102 communicates with the target IHS 104 to identify version information for some, most, or all updatable software images on the target IHS 104, and communicates with the vendor support site 106 to identify the latest software version available for each updatable software image. If the updatable software image is to be updated, the software updating device 102 downloads the updatable software image from the vendor support site 106, and communicates with the target IHS 104 to update that updatable software image on the target IHS 104. In one embodiment, the software updating device 102 may instruct the target IHS 104 to boot in an accessory mode such that the only operations allowed are for the purpose of updating the updatable software images on the target IHS 104. In another embodiment, the target IHS 104 may, while in the accessory mode, validate the authenticity of the software updating device 102 (e.g., using a shared secret passcode) so that only the software updating device 102 is allowed to communicate with the target IHS 104 in order to reduce or alleviate any illicit usage of the target IHS 104 while in the accessory mode. Additional details of the software updating system 100 will be described in detail herein below.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be any type of computing device, such as a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

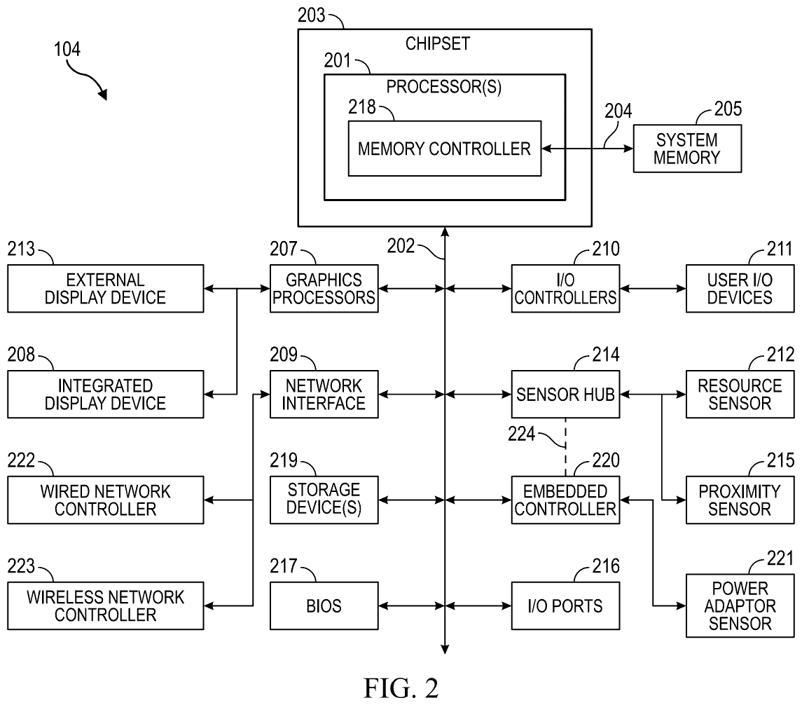

FIG. 2 is a block diagram illustrating components of an example IHS 104 that may be configured to provide the storage updating system 100 according to one embodiment of the present disclosure. For example, IHS 104 may be incorporated in whole, or part, as software updating device 102 or target IHS 104 of FIG. 1. As shown, IHS 104 includes one or more processors 201, such as a Central Processing Unit (CPU), that execute code retrieved from system memory 205. Although IHS 104 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC©, ARM®, SPARC®, or MIPS® ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 104 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 104 utilizes chipset 203 that may include one or more integrated circuits that are connected to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 104, bus 202 is illustrated as a single element. Various embodiments may utilize any number of separate buses to provide the illustrated pathways served by bus 202.

In various embodiments, IHS 104 may include one or more I/O ports 216 that may support removable couplings with diverse types of external devices and systems, including removable couplings with peripheral devices that may be configured for operation by a particular user of IHS 104. For instance, I/O 216 ports may include USB (Universal Serial Bus) ports, by which a variety of external devices may be coupled to IHS 104. In addition to or instead of USB ports, I/O ports 216 may include diverse types of physical I/O ports that are accessible to a user via the enclosure of the IHS 104.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 104 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 104. User I/O devices 211 may interface with an I/O controller 210 through wired or wireless couplings supported by IHS 104. In some cases, I/O controllers 210 may support configurable operation of supported peripheral devices, such as user I/O devices 211.

As illustrated, a variety of additional resources may be coupled to the processor(s) 201 of the IHS 104 through the chipset 203. For instance, chipset 203 may be coupled to network interface 209 that may support diverse types of network connectivity. IHS 104 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support diverse types of network connectivity, such as the network connectivity utilized by IHS 104.

Chipset 203 may also provide access to one or more display device(s) 208 and 213 via graphics processor 207. Graphics processor 207 may be included within a video card, graphics card or within an embedded controller installed within IHS 104. Additionally, or alternatively, graphics processor 207 may be integrated within processor 201, such as a component of a system-on-chip (SoC). Graphics processor 207 may generate Display information and provide the generated information to one or more Display device(s) 208 and 213, coupled to IHS 104.

One or more Display devices 208 and 213 coupled to IHS 104 may utilize LCD, LED, OLED, or other Display technologies. Each Display device 208 and 213 may be capable of receiving touch inputs such as via a touch controller that may be an embedded component of the Display device 208 and 213 or graphics processor 207, or it may be a separate component of IHS 104 accessed via bus 202. In some cases, power to graphics processor 207, integrated Display device 208 and/or external Display device 213 may be turned off, or configured to operate at minimal power levels, in response to IHS 104 entering a low-power state (e.g., standby).

As illustrated, IHS 104 may support an integrated Display device 208, such as a Display integrated into a laptop, tablet, 2-in-1 convertible device, or mobile device. IHS 104 may also support use of one or more external Display devices 213, such as external monitors that may be coupled to IHS 104 via distinct types of couplings, such as by connecting a cable from the external Display devices 213 to external I/O port 216 of the IHS 104. In certain scenarios, the operation of integrated displays 208 and external displays 213 may be configured for a particular user. For instance, a particular user may prefer specific brightness settings that may vary the Display brightness based on time of day and ambient lighting conditions.

Chipset 203 also provides processor 201 with access to one or more storage devices 219. In various embodiments, storage device 219 may be integral to IHS 104 or may be external to IHS 104. In certain embodiments, storage device 219 may be accessed via a storage controller that may be an integrated component of the storage device. Storage device 219 may be implemented using any memory technology allowing IHS 104 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 104 also includes Basic Input/Output System (BIOS) 217 that may be stored in a non-volatile memory accessible by chipset 203 via bus 202. Upon powering or restarting IHS 104, processor(s) 201 may utilize BIOS 217 instructions to initialize and test hardware components coupled to the IHS 104. BIOS 217 instructions may also load an operating system (OS) (e.g., WINDOWS, MACOS, iOS, ANDROID, LINUX, etc.) for use by IHS 104.

BIOS 217 provides an abstraction layer that allows the operating system to interface with the hardware components of the IHS 104. The Unified Extensible Firmware Interface (UEFI) was designed as a successor to BIOS. As a result, many modern IHSs utilize UEFI in addition to or instead of a BIOS. As used herein, BIOS is intended to also encompass UEF.

As illustrated, certain IHS 104 embodiments may utilize sensor hub 214 capable of sampling and/or collecting data from a variety of sensors. For instance, sensor hub 214 may utilize hardware resource sensor(s) 212, which may include electrical current or voltage sensors, and that are capable of determining the power consumption of various components of IHS 104 (e.g., CPU 201, GPU 207, system memory 205, etc.). In certain embodiments, sensor hub 214 may also include capabilities for determining a location and movement of IHS 104 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user's presence near IHS 104, absence from IHS 104, and/or distance from IHS 104 (e.g., near-field, mid-field, or far-field).

In certain embodiments, sensor hub 214 may be an independent microcontroller or other logic unit that is coupled to the motherboard of IHS 104. Sensor hub 214 may be a component of an integrated system-on-chip incorporated into processor 201, and it may communicate with chipset 203 via a bus connection such as an Inter-Integrated Circuit (I²C) bus or other suitable type of bus connection. Sensor hub 214 may also utilize an I²C bus for communicating with various sensors supported by IHS 104.

As illustrated, IHS 104 may utilize embedded controller (EC) 220, which may be a motherboard component of IHS 104 and may include one or more logic units. In certain embodiments, EC 220 may operate from a separate power plane from the main processors 201 and thus the OS operations of IHS 104. Firmware instructions utilized by EC 220 may be used to operate a secure execution system that may include operations for providing various core functions of IHS 104, such as power management, management of operating modes in which IHS 104 may be physically configured and support for certain integrated I/O functions.

EC 220 may also implement operations for interfacing with power adapter sensor 221 in managing power for IHS 104. These operations may be utilized to determine the power status of IHS 104, such as whether IHS 104 is operating from battery power or is plugged into an AC power source (e.g., whether the IHS is operating in AC-only mode, DC-only mode, or AC+DC mode). In some embodiments, EC 220 and sensor hub 214 may communicate via an out-of-band signaling pathway or bus 224.

In various embodiments, IHS 104 may not include each of the components shown in FIG. 2. Additionally, or alternatively, IHS 104 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

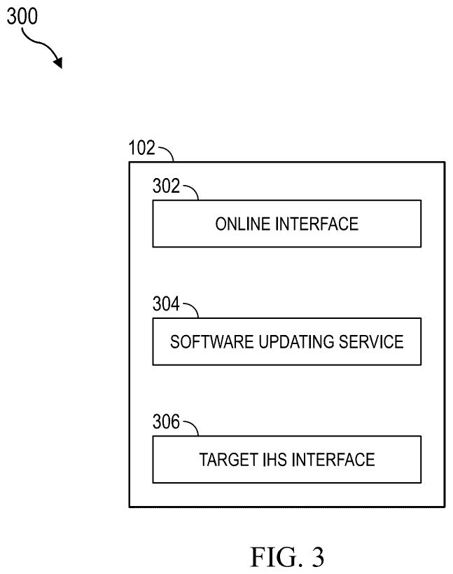

FIG. 3 illustrates several components of the software updating device 102 that may be used to implement the in transit or storage software updating system 100 according to one embodiment of the present disclosure. The software updating device 102 includes an online interface 302, a software updating service 304, and a target IHS interface 306. While the software updating service 304 is shown as being implemented on a dedicated device, it should be appreciated that the software updating service 304 may be implemented on any suitable component of the IHS 104, such as on a BIOS 217 portion of the IHS 104 such that a dedicated device would not be necessary.

The target IHS interface 306 may communicate with the target IHS 104 using any suitable protocol. In one embodiment, the connector 110 may be an RJ-45 connector such that the target IHS interface 306 may communicate with the target IHS 104 using an Ethernet protocol. In another embodiment, the connector 110 may be a USB connector such that the target IHS interface 306 may communicate with the target IHS 104 using a USB On-The-Go (OTG) protocol. Additionally, the vendor support site interface 302 may communicate with the vendor support site 106 over any publicly available communication network, such as the Internet. In one embodiment, the software updating service 304 may be dedicated to only perform software updates such that any potential illicit usage may be reduced or eliminated. That is, the vendor support site interface 302 may be limited to only communicating with the vendor support site 106 over the publicly accessible network to reduce or eliminate any potential illicit usage.

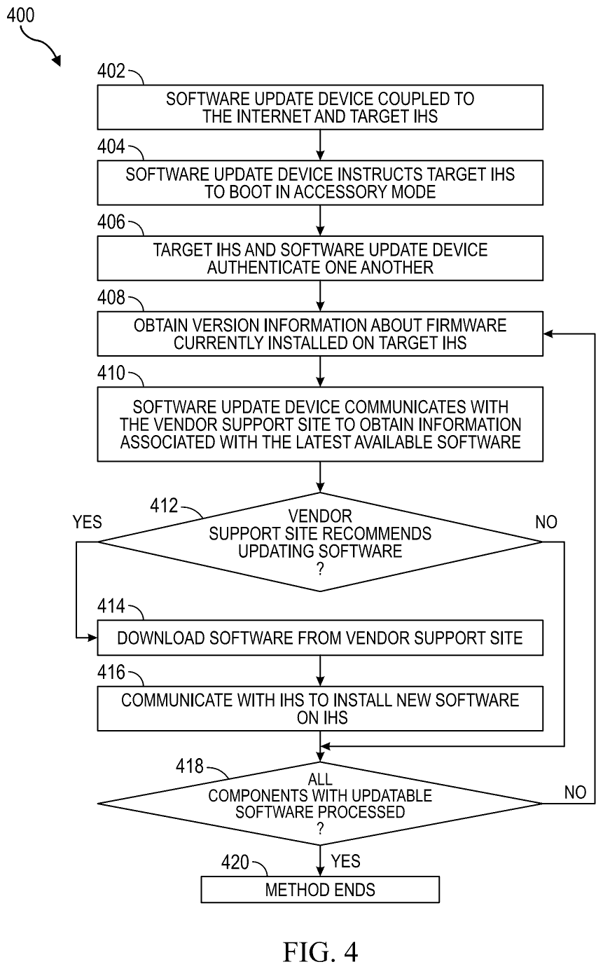

FIG. 4 illustrates an example in transit or storage software updating method 400 that may be used to update the software on an IHS 104 while in transit or in storage according to one embodiment of the present disclosure. Additionally or alternatively, the method 400 may be performed in whole or in part by the software updating service 304 described above with reference to FIG. 3. The method 400 may be performed at any suitable time, such as any time after manufacture of the IHS 104 and before end user has access to the IHS 104. In one embodiment, the method 400 may be performed while the IHS 104 is housed in its shipping container.

Initially at step 402, the software updating device 102 is coupled to the vendor support site 106 and target IHS 104. In one embodiment, the software updating device 102 is coupled to the target IHS 104 via a connector 110 configured on a shipping container that the target IHS 104 is housed in. At step 404, the software updating device 102 instructs target IHS 194 to boot in an accessory mode in which some, most, or all other operations other than updating software are prohibited. Additionally, while in the accessory mode, the target IHS 104 may be limited to communicating only with the software updating device 102. Also, the software updating device 102 may be limited to communicating only with the target IHS 104. At step 406, the target IHS 104 and software updating device 102 authenticate one another, such as by using a shared secret key.

Steps 408-418 may be performed for each element of updatable software on the target IHS 104. Following authentication, the software updating device 102 obtains version information about the software currently installed on target IHS at step 408. The software may include the OS as well as other components (e.g., NIC cards, I/O cards, NVMe storage devices, etc.) that have updatable software.

At step 410, the software updating device 102 communicates with the vendor support site 106 to obtain information associated with the latest available software. If a newer version is available, the software updating device 102 may query the vendor support site 104 to determine if software for that component should be updated. For example, the target IHS 104 may identify one or more dependencies to the latest version of software, and have those dependent software images downloaded and installed if necessary. For another example, the target IHS 104 may recommend updating software only under certain conditions (e.g., update if existing version is v3.54 or earlier). At step 412, if the target IHS 104 recommends updating software, processing continues at step 414; otherwise, processing continues at step 418.

At step 414, the software updating device 102 downloads the software from the vendor support site 106, and communicates with the target IHS 104 to have it installed on the target IHS 104 at step 416. Thereafter, processing continues at step 418 in which the software updating device 102 determines whether all components with updatable software have been processed. If so, processing continues at step 420 in which the method 400 ends. If, however, additional software for other components need processing, processing continues at step 408 to process software for other components.

Although FIG. 4 describes an example method 400 that may be performed to update software on a target IHS 104 while in transit or in storage, the features of the method 400 may be embodied in other specific forms without deviating from the spirit and scope of the present disclosure. For example, the method 400 may perform additional, fewer, or different operations than those described in the present example. For another example, the method 400 may be performed in a sequence of steps different from that described above. As yet another example, certain steps of the method 400 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution, cause the IHS to, after manufacture of a target computing device and before end user access to the target computing device:
communicate with a vendor support site to identify a version of software on the target computing device;
download the version of software from the vendor support site; and
communicate with the target computing device to install the version of software on the target computing device.

2. The IHS of claim 1, wherein the program instructions, upon execution, further cause the IHS to perform the acts of communicating with the vendor support site, downloading the version of software, and communicating with the target computing device are performed when the target computing device is housed in a shipping container.

3. The IHS of claim 2, wherein the program instructions, upon execution, further cause the IHS to communicate with the target computing device via a connector configured on the shipping container.

4. The IHS of claim 1, wherein the program instructions, upon execution, further cause the IHS to communicate with the target computing device using at least one of an Ethernet protocol or a USB On-The-Go (OTG) protocol.

5. The IHS of claim 1, wherein the program instructions, upon execution, further cause the IHS to inhibit the instructions from communicating with any other entity than the vendor support site.

6. The IHS of claim 1, wherein the program instructions, upon execution, further cause the IHS to inhibit the instructions from performing any other operations on the target computing device other than installing the version of software.

7. The IHS of claim 1, wherein the program instructions, upon execution, further cause the IHS to mutually authenticate with the target computing device.

8. The IHS of claim 1, wherein the program instructions, upon execution, further cause the IHS to perform the acts of communicating with the vendor support site, downloading the version of software, and communicating with the target computing device to update a plurality of components on the target computing device.

9. A software updating method comprising:
after manufacture of a target computing device and before end user access to the target computing device:
communicating with a vendor support site to identify a version of software on the target computing device;
downloading the version of software from the vendor support site; and
communicating with the target computing device to install the version of software on the target computing device.

10. The software updating method of claim 9, further comprising performing the acts of communicating with the vendor support site, downloading the version of software, and communicating with the target computing device when the target computing device is housed in a shipping container.

11. The software updating method of claim 10, further comprising communicating with the target computing device via a connector configured on the shipping container.

12. The software updating method of claim 9, further comprising communicating with the target computing device using at least one of an Ethernet protocol or a USB On-The-Go (OTG) protocol.

13. The software updating method of claim 9, further comprising inhibiting the instructions from communicating with any other entity than the vendor support site.

14. The software updating method of claim 9, further comprising inhibiting the instructions from performing any other operations on the target computing device other than installing the version of software.

15. The software updating method of claim 9, further comprising performing the acts of communicating with the vendor support site, downloading the version of software, and communicating with the target computing device to update a plurality of components on the target computing device.

16. An Information Handling System (IHS), comprising:
a processor; and
a memory coupled to the processor, the memory having program instructions stored thereon that, upon execution, cause the IHS to, when a target computing device is at least one of in transit or in storage:
communicate with a vendor support site to identify a version of software on the target computing device;
download the version of software from the vendor support site; and
communicate with the target computing device to install the version of software on the target computing device.

17. The IHS of claim 16, wherein the program instructions, upon execution, further cause the IHS to perform the acts of communicating with the vendor support site, downloading the version of software, and communicating with the target computing device are performed when the target computing device is housed in a shipping container.

18. The IHS of claim 17, wherein the program instructions, upon execution, further cause the IHS to communicate with the target computing device via a connector configured on the shipping container.

19. The IHS of claim 16, wherein the program instructions, upon execution, further cause the IHS to inhibit the instructions from communicating with any other entity than the vendor support site.

20. The IHS of claim 16, wherein the program instructions, upon execution, further cause the IHS to inhibit the instructions from performing any other operations on the target computing device other than installing the version of software.
